(19) United States
(12) Patent Application Publication
(10) Pub. No.: US 2002/0027107 A1
(43) Pub. Date: Mar. 7, 2002

(54) Method for purifying and neutralizing polluted liquids and apparatus for implementing the method

(75) Inventor: Vitaly Sergeevich Andreev, Saint Petersburg (RU)

Correspondence Address: FITCH EVEN TABIN AND FLANNERY, 120 SOUTH LA SALLE STREET, SUITE 1600, CHICAGO, IL, 606033406

(73) Assignee: EET Inc.

(21) Appl. No.: 09/855,181

(22) Filed: May 14, 2001

(30) Foreign Application Priority Data
May 16, 2000 (RU) 2000111960

(51) Int. Cl. C02F 1/46

(52) U.S. Cl. 210/748; 210/669; 210/799; 210/243; 210/263

(57) ABSTRACT

Proposed is a method for purifying and neutralizing polluted liquids, which method comprises the steps of: passing the liquid through a dispersed filtering material with particles of size 0.1-3.0 mm and additional electrode cells; before and after said passing of the liquid through the filtering material periodically regenerating a filter and applying electrical field to the filtering material in purification and/or regeneration stages wherein in the purification and neutralizing stages the filtering material and electrodes are distributed throughout the working volume in the ratio of 0.1-10.0 cm3/cm2 and compacting the same; discharging electrolysis gases in the direction not coinciding with the direction of purified liquid flow, and carrying out the regeneration stage by combined purification of both the filtering material and the electrodes in a flow of slurry formed while loosening the dispersed material in inter-electrode regions by a factor of 1.2 to 3.0.

Proposed is an apparatus for purifying and neutralizing polluted liquids.

The invention relates to physicochemical means for purifying and neutralizing liquid media, such as various solvents polluted with toxic or undesirable for other reasons components which are to be removed or transformed to produce non-toxic substances.

The prior art closest to the present invention is a method and a two-electrode apparatus with additional electrode cells and a regeneration reservoir communicating via a pipe with the upper part of a housing, described in German application DE 44 11 823 A1 (filed Mar. 3, 1994, published Oct. 12, 1995), which is based on RU patents Nos. 2077955, 1994 and 2080302, 1993. The prior art combines advantages of filtering and electrolytic systems to enhance the operating resource and improve the purification ability of the method owing to the use of a dispersed polarized filler as a filtering material. The method provides applying voltage between electrodes in at least one of the two process stages: purification of liquid or regeneration of the filtering material.

A disadvantage of the closest prior art is that the potentialities of the physicochemical approach are incompletely used and, respectively, insufficient purification and regeneration efficiency of the described electrical treatment method.

The above deficiencies are resulting from:

unused flotation processes;

insufficiently efficient removal of gases dissolved in liquid;

low activity of processes of electrolytic purification and neutralization of liquids by electric oxidation, electric reduction of toxic components and electric destruction of corpuscular pollutions;

gradual reduction in intensity of electric retention of coagulated and aggregated pollutions which continuously cluster near particles of the dispersed filler at repeated regeneration, due to incomplete washing of the densely packed filler;

insufficient filtering ability caused by loose packing of the filtering material when upward streams of the liquids being purified are used;

pollution of electrodes with electrolysis products and insoluble components of the liquid being purified;

insufficiently efficient purification of oils and other hydrophobic or viscous liquids;

slipping of pollutions which have not passed through the entire complex of electrochemical trasformations along surfaces of electrodes of only one type (cathodes or anodes) and smooth walls of the working chamber;

the necessity to employ too high electric energies or too expensive polarizable materials (ferroelectric ceramic pellets with dielectric permeability of several thousand units) in sterilization of liquid media;

impossibility to employ simple (on-off) automation systems;

insufficient ability of electrolytic correction or adjustment of pH of the liquids being treated, especially those having a high initial pollution degree.

In some cases of employing the closest prior art method and apparatus (for example, in removing microorganisms and other microparticles) it is required to use high electric field strength, this increasing electric hazard of the process.

In other cases, when purifying water from petroleum derivatives, due to a relatively low sorption capacity of ferroceramic with respect to hydrophobic petroleum derivatives it is required to use relatively low velocities of pumping the liquids being purified, and regeneration should be carried out with the application of relatively high electric field strengths which is unprofitable in terms of energy.

The object of the invention is to provide a more efficient and safe method and apparatus suitable to solve various tasks of purification and neutralization of liquid media in different fields of economy. The entire process have been approached as a complex, including regeneration stage without which no technology may be practiced and fully assessed in comparison with the others.

The object of the invention is attained in a method involving a number of steps known from the prior art, wherein in the purification and neutralization stage the filtering material and the electrodes are distributed in the working volume in a specific fashion: in the ratio of 0.1-10.0 cm³/cm²; electrolysis gases and accompanying gases (dissolved in the liquid medium) are discharged in the direction which does no coincide with the direction of the liquid being purified; and regeneration stage is carried out as a combined purification of both the filtering material and the electrodes in a flow of slurry formed while loosening the dispersed material in inter-electrode zones by a factor of 1.2-3.0.

The liquid media purification and neutralization stage, along with aggregation and electric retention of polarized particles on the filler pellets by electrolysis, oxidation and reduction of pollutants on electrode surfaces and in near-electrode spaces, comprises a further flotation carry-over of a part of pollutions from the flow of liquid being purified. Furthermore, gases dissolved in liquid are removed by “blowing” them with electrolysis gases formed on electrodes at electric current flow. This is provided by the fact that, in contrast to the prior art, the flow of liquid being purified is directed opposite or at a right angle to the direction of gases. Thus, the purification efficiency is improved.

The increased number (increased relative density) of electrodes in the dispersed material filling the working chamber provides the required relative intensity of electric regeneration of gases and flotation processes, respectively, as well as the increased specific efficiency of all electrode processes as a whole. This is equally important both in the processes of electric purification of liquids, and electric regeneration of the filtering material. Moreover, the presence of a required number of near-electrode zones filled with dispersed particles of the filtering material provides a required delay of foreign materials to be electrically destructed in zones where they are actively affected by electrolytic factors.

The ratio of 0.1-10.0 cm³/cm² which defines the saturation degree of the dispersed filler with active electrode surfaces, or in other words, specifies the inter-electrode distance, provides the required improvement in the efficiency of the liquid purification and neutralization processes.

With greater distances between the electrodes, the efficiency of electrode processes will be insufficient. With smaller distances, the system will not be filled with the filtering material having a required dispersion degree. With smaller size of dispersed particles, slippage of pollutions which cannot be transformed by electrodes of this type (for example, clay particles or the like) significantly increases due near-wall sliding of liquids.

When a considerable amount of microorganisms or other microparticles is present in the liquid being purified, efficiency of the invented method may be significantly improved by passing the liquid, in accordance with the prototype, through a ferroelectric material with an abnormally high polarizability (ε>10⁴) or at least through a layer of such material which forms only a part of the used dispersed material. However, it should be taken into account that such materials are very expensive and currently their cost further increases due to the arising shortage of a number of components, e.g. tin. Therefore, in the present invention it is proposed to use another highly polarized material, a ion-exchange resin. Owing to the unipolar mechanism of their electric conduction, the ion-exchange resins also exhibit an abnormally high polarizability. Effective dielectric permeability of ionites reaches the values even of order 10⁵ irrespective of the resin form and the type of counterions. This renders the ion-exchange materials maximum highly efficient in electric retention of microorganisms, their fragments and other microparticles. This, in turn, provides the possibility to decrease the relative amount of highly polarizable material in the total volume of filtering composition and, what is very important, reduce the voltage across the electrodes up to quite safe values of 6-12 V.

In this case, the ion-exchange properties exhibited by ionites in the absence of electric field do not play any role, thus the ion-exchange resins in normal conditions cannot be used as efficient sorbents of microparticles. In view of these circumstances, as well as complexity and consumption of reactants, associated with chemical regeneration of ionites, the inventor suggests the employment of ionites already balanced with salt background of the liquids being purified, i.e. at the final stage of the purification process, when the ion background has been already stabilized.

To provide the above process scheme, the filtering material may be a two-layer composition of 99-85% by volume of a granular non-sorptive material with a specific weight of no less than 1.5 g/cm³, and 1-15% by volume of an ion-exchange resin. However, the greater flotation ability of ion-exchange resins as compared to majority of dielectrics used in electric sorption systems imposes its peculiar feature on the method of regenerating two-layer systems containing ionites.

In particular, consider the most frequently used purification method carried out in dynamic conditions and cyclically alternating with regeneration of working elements. In this case, the liquid flow should be directed from the bottom upwards, and the regeneration liquid flow should be stopped at the end of each regeneration cycle for 0.5-2.0 min. The flow stoppage is needed in order to stratify the filtering dispersion upon turbulent washing in the suspended state. Note, that the regeneration efficiency may be substantially and notably improved by effecting ionite polarization in a separate electrode cell of symmetric type at the very end of the complex purification process.

In cases where water is purified from petroleum derivatives by their coalescence around particles of the dispersed filler, the latter is polarized in electrical field in the regeneration stage. This allows the displacement of oil hydrocarbons having a lower polarity than water from surfaces of the filler particles (see RU 2080302). In such situations, the method efficiency may be improved by using synthetic hydrophobic polymers or any granular materials with hydrophobic coatings, this promoting binding and following coalescence of hydrophobic petroleum derivatives on the surface of the filtering material.

Now consider the opposite situation, but with the same type of the filtering material regeneration, —in electric field. Frequently the need arises to purify liquid mixtures based on a hydrophobic solvent, for example, polluted technical or food oils. In such cases, prior to commencing the purification process, the filtering material should be made hydrophilic. This can be attained by wetting the dispersed filler with water volume passed through the system at the beginning of the purification process.

Up to now, no method steps have been practiced or disclosed in literature to improve efficiency of liquid purification with the use of electrode systems by reduction in various slippages: along the working chamber walls or the electrodes of only one type: only cathodes, or only anodes. As the result, significant amounts of undesirable components, which have not passed the electric chemical treatment or have not been retained by the dispersed material, penetrate the purified medium. This is true for both ionized components, and microparticles. To prevent this disadvantageous situation, the inventor suggests that the same flows of the liquid being purified be directed alternatively along surfaces of cathodes and anodes, and the velocity of the flows slipping along the working chamber walls be reduced.

This may be attained by passing, prior to commencing the purification process, a clean solvent or the purified liquid through the filtering material during 0.5-2.0 min with a flow rate of 0.01-10.0 cm/s. In the latter case, as has been shown by experiments, the developed stabilized structure has time to be destructed, and the system electrical conduction takes on its normal value for the flow.

The object of the invention is also attained owing to a principle improvement in the regeneration stage which cyclically takes turns with the purification stage, thereby defining the efficiency of the purification process as a whole.

The inventor proposes that the regeneration be effected by simultaneously purifying both the dispersing material and the electrode surfaces subjected to pollution while purifying liquids. The simultaneous purification is provided by mechanical (abrasive to some extent) interaction of particles of the filtering filler being loosened, both among them, and with electrode surfaces. Bubbling of the gases remained after electrolysis attached to the solid phase, and gases additionally admitted in the washing step, also promotes intensification of the regeneration process. The combined regeneration process of all working elements may be intensified by passing the regeneration liquid flow in the direction coinciding with the stream of gas bubbles released in electrolysis or that of gas admitted additionally.

The greatest efficiency is then provided by bubbling, from outside, gas bubbles of size 0.1-10 mm with a relative intensity of 0.01-0.1 dm³/s per 1 dm³ of the filtering material. Smaller or larger gas bubbles cause drastic deterioration in the washing efficiency. Similar situation arises with lower or higher intensities of the gas supply.

Loosening of the filtering filler to a lesser extent than 1.3 times leads to insufficient loosening of the dispersed material and does not provide the formation, in the inter-electrode space, of slurry actively washing all of the elements.

With loosening of the filtering filler to a greater extent than 3.0 times, although good washing of the filtering material as such is ensured, its too low density prevents mechanical and abrasive cleaning of the electrodes.

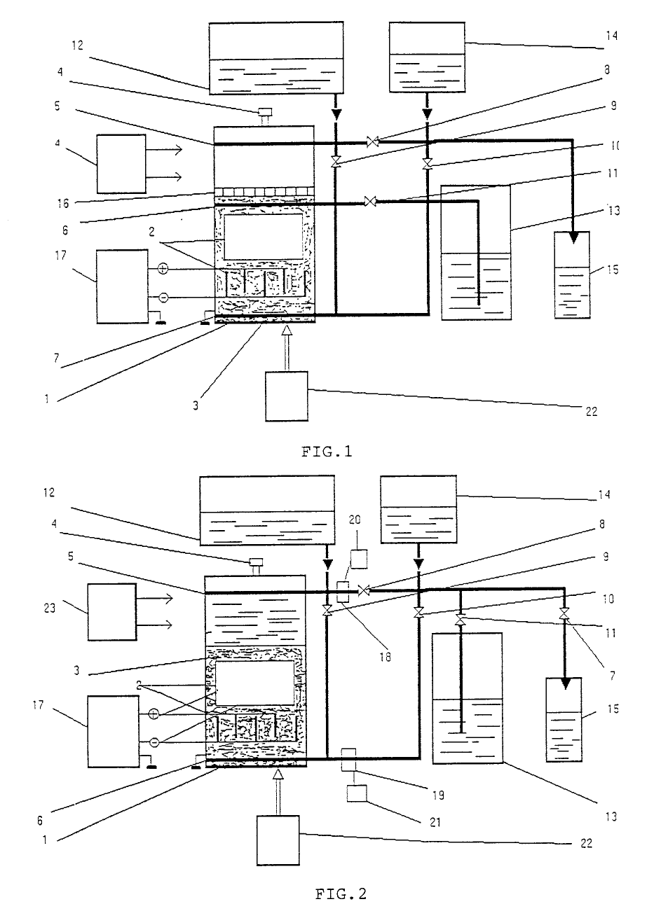

To practice the method, an apparatus has been designed, embodiments of which are schematically shown in FIGS. 1 and 2.

The apparatus comprises a housing 1 with transverse ridges, the housing encompassing electrode packs 2 including parallel electrodes and a filtering material 3. The electrodes contained in one of the packs are located at right angles to the electrodes in another pack. A gas-separation valve 4 is provided on an upper lid of the housing. The housing comprises pipelines 5 to 7 provided with tees. The housing of the apparatus shown in FIG. 1 has three pipelines. The housing of the apparatus shown in FIG. 2 has only two pipelines. Gates 8 to 11 may be provided on the pipelines. The pipelines may connect the housing to a starting (polluted) liquid reservoir 12, a purified (neutralized) liquid collection reservoir 13, a regeneration liquid reservoir 14, and a spent regeneration liquid drain reservoir 15. A pressing plate 16 with a mechanical or electromechanical actuator to lift the plate for releasing the filtering material is mounted above the filtering material with the electrode system. A perforated plate with apertures having an effective size of no greater than 25 mm may be also mounted, as a pressing member, above the filtering material with the electrode system. A power supply 17 is intended to polarize the filtering material in the housing. A pressure or flow sensor electrically coupled to a voltage source may be provided at inlet or outlet branches of the housing. In this case the power supply should comprise a de-energizer. Additional electrode cells 18, 19 coupled to separate lines or power supply units 20, 21 are connected to inlet and/or outlet of the housing. The total areas of anodes and cathodes in the electrode cells differ in size by a factor of 1.5 or more, the relationships between the total areas of the electrodes in inlet and outlet cells being opposite. The additional electrode cells at inlet and outlet of the apparatus may be equipped with devices consisting of semi-permeable membranes which divide the cells into anode and cathode chambers, and with inlet and outlet nipples in the formed chambers, having throttles to provide different space velocities of partial flows passing along cathodes and anodes. At least one of the additional electrode cells may be symmetric and filled with an ion-exchange resin balanced by the ion content with the liquid passing through it. One or more pipes connected to a compressor 22 are provided in the lower part of the housing. Gates on the pipelines may be electromagnetically controlled and connected to a timer 23 specifying the operation time diagram for cleaning and regeneration of working elements of the apparatus. A monoblock distributing system with a timer to provide carrying out all operations of purification of liquids and regeneration of working elements of the apparatus according to a predetermined routine may be also connected to the housing.

The following features of the above apparatus distinguish the same over the closest prior art:

pipelines with flow distributors, separated from the filtering material by a protective screen with cells of a size smaller than 0.1 mm, are mounted in the housing above and under electrodes; the pipelines are provided, on the side opposite to the distributors, with tees which allow switching an upper distributor to supply the liquid being purified or collect the regeneration liquid, and switching the lower distributor to collect the purified liquid or supply the regeneration liquid; the upper lid of the housing is provided with a gas-separation valve;

a pressing unit in the form of a perforated plate with an effective size of apertures no greater than 25 mm, or a solid plate equipped with a mechanical or electromechanical actuator to lift the plate for releasing the filtering material is mounted above the filtering material with the electrode system, in this case an additional pipeline with a flow distributor and a tee at the end opposite to the distributor is provided under the pressing plate to discharge the purified and neutralized liquid or drain the washing liquid after regeneration;

in all of the aforementioned cases a greater degree of compacting the filtering material is provided which ensures a greater filtering degree and addition of flotation processes intensifying the purification;

the additional electrode cells at inlet and/or outlet of the apparatus are connected to separate channels or power supply units and have the total areas of anodes and cathodes differing in size by a factor of 1.5 or more, this allowing the adjustment of pH of aqueous solutions within the range from 3 to 11. When the cells are simultaneously used at inlet and outlet of the apparatus, the relationship between the total areas of electrodes in the inlet and outlet cells is opposite, this allowing, on variation of pH in course of the electrical treatment, to further return the characteristic to normal value;

the additional electrode cells at inlet and/or outlet of the apparatus are equipped with devices consisting of semi-permeable membranes and throttles and providing different space velocities of the general flow components passing along cathodes and anodes, this allowing pH to be adjusted within the range from 2 to 13;

at least one of the additional electrode cells is filled with an ion-exchange resin balanced by the ion content with the liquid passing through it;

a pressure or flow sensor electrically coupled to a voltage source is provided at inlet or outlet branch, in this case the source is equipped with a device which de-energizes the electrodes;

one or more pipelines connected to a compressor are provided in the lower part of the housing;

owing to the above method, the apparatus operation algorithm permits the use of an on-off automation system by providing the pipelines with electromagnetically controlled gates connected to a timer which specifies the operation time diagram for cleaning and regeneration of working elements of the apparatus;

the automation system based on the electromagnetic gates may be replaced with a monoblock distribution system with a timer to provide carrying out all steps of purification of liquid and regeneration of working elements of the apparatus in accordance with a predetermined routine;

the electrode systems within the housing of the purification apparatus are divided into two or more packs placed in succession along the liquid flow, with parallel electrodes which are located at right angles (if the electrodes are planar) or transversely (if the electrodes are non-planar) to surfaces of the electrodes in any one of the adjacent packs, and inner surfaces of the housing are provided with ribs or ridges normal to the direction of the flow of liquid being purified.

The apparatus operates in the following fashion. The electrode system 2 and the filtering dispersed material 3 are arranged in the housing 1 in the ratio of (0.1-10.0 cm³/cm²) to provide a required efficiency of the processes of electric sorption of pollutions on the polarizable filling with a sufficient activity of electric purification and neutralization of liquids by electric oxidation, electric reduction of toxic components and electric destruction of corpuscular pollutions. Volume of the dispersed filling should be 1.2-3.0 times less than the housing capacity.

While using the embodiment with tree pipelines and a pressing unit, the dispersed filler is compacted, prior to purification, mechanically (by a driver) or hydraulically (by the reverse flow of liquid through apertures in the pressing plate). Then, in the first stage of purification and neutralization the polluted liquid is supplied into the housing from the reservoir 12 via the lower pipeline. In the embodiment with two pipelines, the starting liquid is fed from the reservoir 12 downward through the upper pipeline and compresses the dispersed filling (presses the filling to the bottom of the housing). In any case, the purification process is carried out by pumping the liquid through the compacted dispersed material. Having passed the active zone of the apparatus, the purified and neutralized liquid is collected in the reservoir 13.

The filler polarization conditions are selected depending on the nature of the liquid to be purified and basic pollutions: either in the first stage (electrical treatment), or in the second stage (electric regeneration). It is possible to use polarization conditions in both stages, but with different values of the polarizing field. In particular, to purify oils from suspended substances, and water from petroleum hydrocarbons emulsified therein, polarization is effected in the regeneration stage. While purifying sewage or consumer water from dissolved impurities and microparticles, the polarization is effected in the first stage, electric sorption and electric transformation of the liquid. However, the presence in the consumer water of significant amount of petroleum derivatives requires polarization to be effected in the regeneration stage as well.

The dispersed material is polarized by enabling the power supply 17.

Impurities contained in the liquid are removed or neutralized in the first stage owing to the complex of physical and chemical processes along with the flotation process, and gradually pollute working elements of the apparatus (both the dispersed filler, and the surface of electrode). In this connection, the necessity periodically arises to regenerate the working elements of the apparatus. To this end (with account of the above statement as to the use of polarization conditions in the first or second stage of the combined process) liquid is supplied into the housing 1 from the reservoir 14 through the lower pipeline, the dispersed filling suspends in the flow and regenerates the dispersed material and electrodes at the same time. The washing process may be intensified by bubbling air with the aid of the compressor 22. The pressing unit with mechanical actuator must be pulled to the upper part of the housing, while with the perforated pressing unit, the dispersed material suspends, as if automatically, owing to penetration of the formed slurry through apertures in the pressing unit. Discharge liquid after regeneration is collected in the reservoir 16. Bubbles of air or electrolysis gases produced in the electrical treatment of liquids are removed through the gas-separation valve 4.

Time sequence and duration of the aforementioned operations in purification of liquids and regeneration of working elements may be programmed using the timer 23 and realized with the aid of electromagnetic gates 11 or the monoblock distributor apparatus. The liquids may be discharged by any conventional method.

The method and apparatus in accordance with the present invention have been practically tested during the last 7 years in a product line being developed, “KASKAD” liquid purification apparatuses of different capacity. Current types of “KASKAD” apparatuses include units with capacity from 50 to 5000 liters. The apparatuses may be controlled both manually or fully automatically. The apparatuses allow purification and neutralization of various liquids: drainage effluents of landfills, household and industrial drainage, bilge water of marine and river vessels, vegetable oil feedstock, various process liquids, drinking water, etc.

Practical applicability of the method and apparatus in accordance with the invention will be further illustrated by examples.

### EXAMPLE 1

Drainage effluent from PTO-3 municipal landfill in the settlement of Novoselki (near Saint-Petersburg) was subjected to purification and neutralization in the apparatus schematically shown in FIG. 1. The work was done within the framework of the European Program, Serial No. LIFETCY98/ROS/095. The apparatus comprised two perpendicular electrode packs, each including 11 electrodes (5 anodes and 6 cathodes). Dimensions of each electrode were 300×400×0.5 mm, with the chamber cross-section of 300×300 mm. The filtering material was quartz sand with grains of size from 0.1 to 0.63 mm. Space velocity of the drainage effluent supply through the apparatus (from the bottom upwards to the center flow distributor) was in the range from 60 to 100 liters per hour. Voltage across the electrodes was 12-15V due to extremely high mineral background (high background conduction of 20 mOhm/cm) and restricted power supply (200 VA). Purified liquid was drained through the center pipeline. Samples were analyzed in the analytic control laboratory of the RAO INSTITUT GIPRONIKEL. Weight concentrations of copper, iron, nickel, chrome were determined by the atom-emission spectrometry method with inductively-confined plasma, using AtomScan 25 spectrometer manufactured by TJN company (USA). The remaining characteristics were determined by nephelometric, photocolorimetric and titrometric methods. Results of purifying the effluent in the first purification cycle are summarized in Table 1 which shows high versatility (taking into account different nature of pollutions) and efficiency of apparatus. As seen in the Table, along with the suspended particles which are responsible for the turbidity characteristic, metal cations remove many organic compounds (defined by the Chemical Oxygen Consumption index (COC) and the Biological Oxygen Consumption index (BOC₅), anions (nitrates) and even readily water-soluble ammonia.

The apparatus was regenerated by a water flow with a space velocity of 300 l/h in the absence of polarizing voltage across the electrodes of the apparatus. The washing water flow was directed from the lower flow distributor throughout the housing to the upper pipeline, this providing intensive flow of slurry throughout the inner space, including near-electrode regions. Having regenerated the apparatus with water during 0.5 h, the purification cycle was repeated. Table 2 summarizes data of the 8^{th} purification cycle. As follows from the Table, the regeneration in these conditions was efficient, and therefore the effectiveness of the purification was not reduced.

TABLE 1
Characteristics of landfill drainage effluent before and after
electrical treatment, first purification cycle, duration 12 hours

| | | Analysis results | Analysis results |
|---|---|---|---|
| | | before electrical | after electrical |
| No. | Measured characteristic | treatment (mg/l) | treatment (mg/l) |
| 1 | Turbidity | 26 | 0.8 |
| 2 | COG | 3700 | 270 |
| 3 | BOC₅ | 410 | 10 |
| 4 | Nitrates (by nitrogen) | 315 | 1.6 |
| 5 | Ammonium (by | 1320 | 2.6 |
| | nitrogen) | | |
| 6 | Chlorides | 2300 | 260 |
| 7 | Copper | 0.34 | 0.032 |
| 8 | Nickel | 0.45 | 0.050 |
| 9 | Chrome (total) | 1.8 | 0.400 |
| 10 | Iron (total) | 11.0 | 0.280 |

TABLE 2
Characteristics of landfill drainage effluent before and after electrical
treatment, eighth purification cycle (after 7 regeneration cycles),
duration 12.5 hours

| | | Analysis results | Analysis results |
|---|---|---|---|
| | | before electrical | after electrical |
| No. | Measured characteristic | treatment (mg/l) | treatment (mg/l) |
| 1 | Turbidity | 26 | 0.7 |
| 2 | COG | 3700 | 265 |
| 3 | BOC₅ | 410 | 9 |
| 4 | Nitrates (by nitrogen) | 315 | 1.7 |
| 5 | Ammonium (by | 1320 | 2.7 |
| | nitrogen) | | |
| 6 | Chlorides | 2300 | 270 |
| 7 | Copper | 0.34 | 0.035 |
| 8 | Nickel | 0.45 | 0.045 |
| 9 | Chrome (total) | 1.8 | 0.350 |
| 10 | Iron (total) | 11.0 | 0.270 |

On the basis of data in Tables 1, 2, one may also conclude that the stage system comprised of the successively connected apparatuses n in FIG. 1 provides the effluent neutralization with reduction of contaminants to the Maximum Permissible Concentration (MPC) levels approved by the State Sanitary and Epidemic Inspection of the Russian Federation.

### EXAMPLE 2

Crude sunflower oil containing suspended organic impurities which formed sediment at long (up to 10 days) settling and turbidity which did not disappear after settling and significantly impaired commercial qualities was purified with the aid of the apparatus whose schematic diagram is shown in FIG. 2, but without additional electrode cell. In view of great viscosity of the basic oil fraction and even more pronounced viscosity of the settled fraction, vegetable oil is not filtered in practice, and an expensive dedicated refining technology is used.

The basic features of the apparatus in FIG. 2 were as follows. The crossed (in plan view) electrode packs, as in Example 1, were comprised of 6 anodes and 7 cathodes each. Electrode dimensions were 460×400×0.5 mm, with the cross-section of the housing of 500×500 mm. The housing was filled with quartz sand with grains of size 0.1-0.63 mm. Before pumping the oil, tap water was passed through apparatus to wet the sand. Flow rate of oil supply (from the top downward) was 100 l/h. Content of the settling fraction was defined by weight. Non-settling fraction was controlled nephelometrically. Tables 3 and 4 summarize the control results of purification of crude oil before and after regeneration of the apparatus, which demonstrate that oil had acquired superior commercial characteristics especially in view of the fact that, in addition to data in the Tables, the purified product had preserved its flavor which usually disappears when refining methods are used.

The apparatus was regenerated (electrically) using 1.5% solution of sodium chloride (common salt) with voltage of 20V applied across the electrodes during 30 min, and a flow rate increasing from 300 to 800 l/h. The regeneration solution flow was fed in the direction from the bottom upward.

TABLE 3
Characteristics of vegetable oil before and after purification
(first purification cycle, 800 kg oil)

| | | Before | After |
|---|---|---|---|
| No. | Characteristic | purification | purification |
| 1 | Settled fraction (mg/l) | 66 | 0 |
| 2 | Turbidity (non-settled fraction) | 26 | 1.4 |

TABLE 4
Characteristics of vegetable oil before and after purification
(15^{th} purification cycle, 850 kg oil)

| | | Before | After |
|---|---|---|---|
| No. | Characteristic | purification | purification |
| 1 | Settled fraction (mg/l) | 68 | 0 |
| 2 | Turbidity (non-settled fraction) | 30 | 1.5 |

### EXAMPLE 3

Waste car motor oil M-5 containing a plurality of suspended impurities forming a sediment when settled and imparting dark color and turbidity to the oil, which do not disappear after settling the oil, was purified in the apparatus schematically shown in FIG. 2 (without additional electrode cells).

Characteristics of the apparatus, purification and regeneration conditions, and measurement methods were as in Example 2, except two aspects: 1) the dispersed filtering material was agate sand with grains of size 0.3-0.6 mm; 2) compressed air bubbles with diameters of about 5 mm were injected from UK-25 compressor into the lower part of the housing through a perforated tube with a capacity of about 0.05 dm³/s. Color of the sample was defined visually. Control results of purification of the motor oil before and after regeneration of the apparatus are shown in Tables 5 and 6, which demonstrate a quite high efficiency of the process.

TABLE 5
Characteristics of motor oil before and after purification
(first purification cycle, 600 kg purified oil)

| | | Before | After |
|---|---|---|---|
| No. | Characteristic | purification | purification |
| 1 | Settled fraction (mg/l) | 47 | 0 |
| 2 | Turbidity (non-settled fraction) | 26 | 1.4 |
| 3 | Color | dark brown | yellow |

TABLE 6
Characteristics of motor oil before and after purification,
12^{th} purification cycle (after 11 regeneration cycles), 550 kg purified oil

| | | Before | After |
|---|---|---|---|
| No. | Characteristic | purification | purification |
| 1 | Settled fraction (mg/l) | 46 | 0 |
| 2 | Turbidity (non-settled | 27 | 1.3 |
| | fraction) | | |
| 3 | Color | dark brown | yellow |

### EXAMPLE 4

The apparatus schematically shown in FIG. 2 (without additional electrode cells) was used to purify bilge water was from oils and diesel fuel penetrated therein in vessel operation. The apparatus comprised two perpendicular electrode packs, each including 9 electrodes (4 anodes and 5 cathodes). Dimensions of every electrode were 300×400×0.5 mm, with the chamber cross-section of 300×300 mm. Polystyrene and divinylbenzene beads with particles of size 0.1-0.3 mm were used as the filtering material. Space velocity of the bilge water supply through the apparatus was 150-200 liters per hour. The flow was passed in the direction from the bottom upwards. Content of petroleum hydrocarbons in water was determined by infrared spectrometry method using SF-26 spectrophotometer (LOMO). Regeneration (electric regeneration) of the apparatus was effected using upward flow of water taken from the Finnish Gulf, containing a sufficient quantity of salts, with the voltage of 50V applied across the electrodes during 20 min, with a space velocity of about 500 l/h. Bilge water purification results depending on the regeneration cycle, illustrating both purification and regeneration efficiency, are summarized in Tables 7 and 8.

TABLE 7
Content of petroleum derivatives in water before and after purification,
first purification cycle, 10 hours

| | Purification stage | Concentration of | Concentration of |
|---|---|---|---|
| | (time passed | petroleum derivatives | petroleum derivatives |
| | from the process | before purification | after purification |
| No. | beginning, hours) | (mg/l) | (mg/l) |
| 2 | 0.25 | 140 | 0.21 |
| 3 | 7.0 | 140 | 0.29 |

TABLE 8
Content of petroleum derivatives in water before and after purification,
20^{th} purification cycle (after 19 regeneration cycles), 8 hours

| | Purification stage | Concentration of | Concentration of |
|---|---|---|---|
| | (time passed | petroleum derivatives | petroleum derivatives |
| | from the process | before purification | after purification |
| No. | beginning, hours) | (mg/l) | (mg/l) |
| 2 | 0.25 | 142 | 0.19 |
| 3 | 6.0 | 142 | 0.27 |

### EXAMPLE 5

Detergent-stabilized oil emulsion commonly used in cutting metals was purified using the apparatus schematically shown in FIG. 2 (without additional electrode cells). Detergents were added to prevent stratification of the emulsion in use, and as this prevented coalescence of oil drops, purification of water from oils was rather complicated in this case.

The apparatus comprised two perpendicular electrode packs, each comprising 9 electrodes (4 anodes and 5 cathodes). Dimensions of each electrode were 300×400×0.5 mm, with the chamber cross-section of 300 ×300 mm. Quartz sand (grains of size 0.1-0.63 mm) treated with acetate solution of silicone and then heated to 90° C. was used as the filtering material. The emulsion was supplied through the apparatus (from the top downward) with a space velocity of about 100 l/h. Content of petroleum oils in water was determined by the infrared spectrophotometry method using SF-26 spectrophotometer (LOMO). The apparatus was regenerated (electrically regenerated) by upward flow of 2% sodium chloride solution with the voltage of 65V applied across the electrodes during 20 min, with a space velocity of about 500 l/h. Oil concentration was assessed indirectly by the COC value after pre-calibrating on the basis of standard mixtures. Results of purifying the water from oil, depending on the regeneration cycle, are listed in Tables 9 and 10.

TABLE 9
Oil content in stabilized emulsion before and after purification,
first purification cycle, 6 hours

| | Purification | | |
|---|---|---|---|
| | stage (time passed | Oil concentration in | Oil concentration in |
| | from the process | water before | water after |
| No. | beginning, hours) | purification (mg/l) | purification (mg/l) |
| 2 | 0.1 | 40 | 1.9 |
| 3 | 5.0 | 40 | 2.1 |

TABLE 10
Content of petroleum products in water before and after purification,
20^{th} purification stage (after 19 regeneration cycles), 6 hours

| | | Concentration of | Concentration of |
|---|---|---|---|
| | Purification stage | petroleum products | petroleum products |
| | (time passed from the | before purification | after purification |
| No. | process start, hours) | (mg/l) | (mg/l) |
| 2 | 0.1 | 42 | 2.0 |
| 3 | 5.5 | 42 | 2.2 |

### EXAMPLE 6

Household effluent from a tanker was purified and neutralized by the apparatus schematically shown in FIG. 1, however, an additional 5-electrode cell of symmetric type filled with KU-23 cation-exchange resin, with 10-12V power supply, was connected to the outlet of the apparatus. The structural features of the main apparatus were as in Example 1.

Voltage across the electrodes of the main apparatus was at the level of 90V. Note that when this type of dispersed filler (quartz sand slightly polarizable in electric field) and the polarization voltage values of 30V and less were used, the neutralization effect disappeared quite completely.

The effluent was directed from the lower pipeline through the center pipeline to the outlet, to which an additional electrode cell might be connected.

Such microbial characteristics as Total Microbial Number (TMN) and Coli index defining the colibacillus concentration were measured.

The apparatus was regenerated with the polarization voltage removed from all electrodes, by water flow with a space velocity of 300 l/h. The washing water flow was directed from the lower flow distributor throughout the housing to the upper pipeline, this providing intense flow of slurry throughout the inner space, including near-electrode regions. The washing was intensified by admission of air from the compressor into the lower part of the housing.

Tables 11 and 12 summarize data defining efficiency of the additional electrode cell with ion-exchange resin in sterilizing liquids with high microflora content. The tables illustrate superior sterilization efficiency of the additional electrode cells with human-safe voltages of up to 12V used.

TABLE 11
Microbiological characteristics of effluent
after first purification and neutralization cycle (7 hours)

| Test variant | TMN (cl/ml) | Coli index |
|---|---|---|
| Check | 5 * 10⁸ | 1 * 10⁴ |
| Without additional cell | 1 * 10³ | 68 |
| With additional cell | 0 | 0 |

TABLE 12
Microbiological characteristics of effluent after 12th purification and
neutralization cycle (11 regeneration cycles), 7 hours

| Test variant | TMN (cl/ml) | Coli index |
|---|---|---|
| Check | 5 * 10⁸ | 1 * 10⁴ |
| Without additional cell | 2 * 10³ | 62 |
| With additional cell | 0 | 0 |

### EXAMPLE 7

Drainage effluent taken from PTO-3 municipal landfill in the settlement of Novoselki (near Saint-Petersburg) was purified and neutralized with the aid of the apparatus schematically shown in FIG. 1. The apparatus comprised two perpendicular electrode packs, each including 11 electrodes (5 anodes and 6 cathodes). Dimensions of every electrode were 300×400×0.5 mm, with the cross-section of the chamber 300×300 mm. The filtering material was quartz sand with grains of size within 0.1-0.63 mm. Space velocity of the effluent supply through the apparatus (in the upward direction up to the center flow distributor) was in the range from 60 to 100 liters per hour. Voltage across the electrodes was 12-15V. The purified liquid was drained via the center pipeline.

Additional electrode cells with membrane separators between cathodes and anodes, and adjustable throttles at outlets of the anode and cathode chambers were mounted at inlet and outlet of the apparatus.

The purification scheme was as follows. The effluent was provided to the inlet of the apparatus through the electrode cell with the power supply set to 100V to adjust pH of the liquid to 2.0-2.5. As the result of such acid treatment, a considerable part of humates (chemical derivatives of humic acids) responsible for increased COC and BOC₅ values was precipitated. A similar electrode cell at the apparatus outlet adjusted pH of the purified effluent to normal values of 6 to 7, corresponding to the RF State Sanitary and Epidemic Inspection requirements.

Weight concentrations of copper, iron, nickel, chrome were determined as in Example 1.

The apparatus was regenerated by water flowing with a space velocity of 300 l/h in the absence of the polarizing voltage across all of the electrodes in the apparatus. The washing water flow was directed from the lower flow distributor throughout the housing to the upper pipeline, this providing intensive flow of slurry throughout the internal space, including near-electrode regions. Upon regenerating the apparatus with water during 0.5 h, the purification cycle was repeated. Data of 6^{th} purification cycle are summarized in Table 14.

Results of the drainage effluent purification are summarized in Tables 13 and 14 which demonstrate that the scheme with the use of additional electrode cells provides a more efficient purification by majority of the parameters than a less complicated apparatus as in Example 1.

TABLE 13
Characteristics of landfill drainage effluent before and after electrical
treatment with additional electrode cells,
first purification cycle, duration 10 hours

| | | Analysis results | Analysis results after |
|---|---|---|---|
| | Measured | before electrical | electrical treatment |
| No. | characteristic | treatment (mg/l) | (mg/l) |
| 1 | Turbidity | 26 | 0.4 |
| 2 | COC | 3700 | 30 |
| 3 | BOC₅ | 410 | 6 |
| 4 | Nitrates (by nitrogen) | 315 | 1.4 |
| 5 | Ammonium (by | 1320 | 2.5 |
| | nitrogen) | | |
| 6 | Chlorides | 2300 | 290 |
| 7 | Copper | 0.34 | 0.035 |
| 8 | Nickel | 0.45 | 0.045 |
| 9 | Chrome (total) | 1.8 | 0.360 |
| 10 | Iron (total) | 11.0 | 0.220 |

TABLE 14
Characteristics of landfill drainage effluent before and after electrical
treatment with additional electrode cells,
sixth purification cycle (after 5 regeneration cycles), duration 8 hours

| | | Analysis results | Analysis results after |
|---|---|---|---|
| | Measured | before electrical | electrical treatment |
| No. | characteristic | treatment (mg/l) | (mg/l) |
| 1 | Turbidity | 26 | 0.5 |
| 2 | COC | 3700 | 32 |
| 3 | BOC₅ | 410 | 6 |
| 4 | Nitrates (by nitrogen) | 315 | 1.3 |
| 5 | Ammonium (by | 1320 | 2.5 |
| | nitrogen) | | |
| 6 | Chlorides | 2300 | 300 |
| 7 | Copper | 0.34 | 0.034 |
| 8 | Nickel | 0.45 | 0.046 |
| 9 | Chrome (total) | 1.8 | 0.350 |
| 10 | Iron (total) | 11.0 | 0.230 |

### EXAMPLE 8

Acid effluent (pH 4,5) of a galvanizing plant, containing ions of copper, nickel, chrome and oil impurities was purified and neutralized.

Electrical treatment was carried out using the apparatus schematically shown in FIG. 2 with the structural features of the basic unit as in Example 5. The apparatus included an inlet three-electrode cell of volume 1 dm³ and a power supply, the cell being configured so that the area of two anodes was 5.5 times that of the cathode. Voltage between cathode and anode was within the range 80-85V. Voltage between the electrodes of the basic unit was 25V. Space velocity of the purified liquid flow was maintained at the level of 180 l/h.

The apparatus was regenerated in two stages. In the first stage, the regeneration was carried out with the flow of 2% solution of sodium chloride with a space velocity of 200 l/h and with 60V voltage applied across the electrodes during 20 min. In the second stage, the voltage was completely removed from the electrodes, and the washing was effected by water during 30 min with the same velocity.

Characteristics of the liquids obtained by the above methods are shown in Tables 15 and 16. pH value was controlled potentiometrically. As seen in the tables, the electrical treatment according to the scheme has not only provided reduction in concentrations of heavy metals and oils, but also increased pH values of the solutions to normal (6-8).

TABLE 15
Characteristics of galvanizing plant effluent before and after electrical
treatment with additional electrode cell,
first purification cycle, duration 4 hours

| | | Analysis results before | Analysis results after |
|---|---|---|---|
| | Measured | electrical treatment | electrical treatment |
| No. | characteristic | (mg/l) | (mg/l) |
| 1 | Oils | 55 | 1.6 |
| 2 | Copper | 0.44 | 0.04 |
| 3 | Nickel | 0.52 | 0.05 |
| 4 | Chrome (total) | 2.8 | 0.07 |
| 5 | pH | 4.5 | 6.2 |

TABLE 16
Characteristics of galvanizing plant effluent before and after electrical
treatment with additional electrode cell,
fifth purification cycle (after 4 regeneration cycles), duration 5 hours

| | | Analysis results before | Analysis results after |
|---|---|---|---|
| | Measured | electrical treatment | electrical treatment |
| No. | characteristic | (mg/l) | (mg/l) |
| 1 | Oils | 58 | 1.8 |
| 2 | Copper | 0.48 | 0.03 |
| 3 | Nickel | 0.56 | 0.04 |
| 4 | Chrome (total) | 3.0 | 0.08 |
| 5 | pH | 4.6 | 6.3 |

### EXAMPLE 9

Chemical plant alkaline (pH 13,2) effluent containing organic impurities was purified and neutralized. Electrical treatment was effected using the apparatus whose diagram is shown in FIG. 2, with the design features of the basic unit as in Example 5. A two-electrode cell of volume 0.8 dm³ with a power supply, comprising anode and cathode chambers divided by a chemically resistant semi-permeable membrane was connected to inlet of the basic unit of the apparatus. Electrode chambers had inlet and outlet nipples. One nipple on each chamber had a throttling unit. Voltage between cathode and anode in the cell was set within 75-85 V. Voltage across the electrodes in the main unit of the apparatus was 40V. Space velocity of the supplied polluted solution was 150 l/h.

The apparatus was regenerated by upward flow of water with a space velocity of 300 l/h and with voltage removed from all electrodes during 30 min. Measured were COC, BOC₅ and pH values.

Electrical treatment results obtained by the methods indicated above are summarized in Tables 17 and 18. The tables demonstrate that the electrical treatment in accordance with the above scheme has reduced COC and BOC₅ values, and also brought pH value of solutions to the normal levels (6-8).

TABLE 17
Characteristics of chemical plant effluent before and after electrical
treatment with additional electrode cell,
first purification cycle, duration 12 hours

| | | Analysis results before | Analysis results after |
|---|---|---|---|
| | Measured | electrical treatment | electrical treatment |
| No. | characteristic | (mg/l) | (mg/l) |
| 1 | Turbidity | 32 | 1.4 |
| 2 | COC | 44 | 29 |
| 3 | BOC₅ | 46 | 5 |
| 4 | pH | 13.2 | 7.1 |

TABLE 18
Characteristics of chemical plant effluent before and after
electrical treatment with additional electrode cell, eighth
purification cycle (after 7 regeneration cycles), duration 8 hours

| | | Analysis results before | Analysis results after |
|---|---|---|---|
| | Measured | electrical treatment | electrical treatment |
| No. | characteristic | (mg/l) | (mg/l) |
| 1 | Turbidity | 33 | 1.5 |
| 2 | COC | 39 | 27 |
| 3 | BOC₅ | 41 | 4 |
| 4 | pH | 13.4 | 7.2 |

### EXAMPLE 10

Water taken from a well located in an industrial zone of the Leningrad region (near Kapitolovo) was subjected to purification and neutralization. Electrical treatment was carried out with the aid of the apparatus described in Example 1 with an additional electrode cell at outlet of the apparatus, filled with ion-exchange resin as in Example 5, and a second electrode cell at inlet of the apparatus as in Example 8. Electrical conditions of operation of all electrode systems were the same as in the aforementioned examples. Well water was passed with a velocity of 400 l/h.

Regeneration was carried out as in Example 1, however, its duration was 1.5 h.

Tables 19 and 20 present analysis results of samples taken from non-purified and purified water, obtained by standard methods used in laboratories of the Vodokanal sanitary and epidemic stations and enterprises in accordance with the standards: GOST D 51232-98 “Drinking water. General requirements to quality control organization and methods” and SanPin 2.1.4.559-96.

The tables demonstrate that the purified water satisfied the RF and WHO standards by all measured characteristics (the remaining characteristics were initially normal).

TABLE 19
Characteristics of water before and after electrical treatment with
additional electrode cells, first purification cycle, duration 12 days

| | | Analysis results | Analysis results |
|---|---|---|---|
| | Measured | before electrical | after electrical |
| No. | characteristic | treatment (mg/l) | treatment (mg/l) |
| 1 | pH | 5.6 | 6.9 |
| 2 | Permanganate oxidability | 12.5 | 3.3 |
| 3 | Petroleum derivatives | 6.2 | 0.05 |
| 4 | Surfactants | 1.2 | 0.2 |
| 5 | Phenol index | 2.9 | 0.25 |
| 6 | Aluminum | 2.2 | 0.35 |
| 7 | Iron | 1.1 | 0.19 |
| 8 | Manganese | 0.6 | 0.05 |
| 9 | Nitrates | 98 | 30 |
| 10 | Nickel | 0.3 | 0.06 |
| 11 | Lead | 0.1 | 0.01 |
| 12 | Chrome (Cr⁶⁺) | 0.28 | 0.02 |
| 13 | Zinc | 7.0 | 1.8 |
| 14 | Color | 23 | 14 |
| 15 | Turbidity | 2.8 | 0.9 |

TABLE 20
Characteristics of water before and after electrical treatment
with additional electrode cells, third purification cycle (after
2 regeneration cycles), duration 10 days

| | | Analysis results | Analysis results |
|---|---|---|---|
| | | before electrical | after electrical |
| No. | Measured characteristic | treatment (mg/l) | treatment (mg/l) |
| 1 | pH | 5.6 | 6.8 |
| 2 | Permanganate oxidability | 12.5 | 3.2 |
| 3 | Petroleum derivatives | 6.2 | 0.04 |
| 4 | Surfactants | 1.2 | 0.1 |
| 5 | Phenol index | 2.9 | 0.23 |
| 6 | Aluminum | 2.2 | 0.38 |
| 7 | Iron | 1.1 | 0.18 |
| 8 | Manganese | 0.6 | 0.07 |
| 9 | Nitrates | 98 | 28 |
| 10 | Nickel | 0.3 | 0.07 |
| 11 | Lead | 0.1 | 0.01 |
| 12 | Chrome (Cr⁶⁺) | 0.28 | 0.01 |
| 13 | Zinc | 7.0 | 2.0 |
| 14 | Color | 23 | 15 |
| 15 | Turbidity | 2.8 | 0.8 |

What is claimed is:

1. A method for purifying and neutralizing polluted liquids comprising: passing the liquid through a dispersed filtering material having a particle size of about 0.1 to about 3.0 mm, and additional electrode cells; wherein before and after said passing of the liquid through the filtering material, periodically regenerating a filler and applying an electrical field to the filtering material in purification and/or regeneration stages, distributing the filtering material and electrodes, in the purification and neutralization stages, throughout the working volume in the ratio of about 0.1 to about 10.0 cm³/cm² and compacting the same; discharging electrolysis gases in the direction not coinciding with the direction of purified liquid flow, and carrying out the regeneration stage by combined purification of both the filtering material and the electrodes in a flow of slurry formed while loosening the dispersed material in inter-electrode regions by a factor of about 1.2 to about 3.0.

2. The method of claim 1 wherein prior to beginning the purification process, pure solvent of the liquid to be purified is passed through the filtering material during about 0.5 to about 2.0 min with a flow rate of about 0.01 to about 10.0 cm/s.

3. The method of claims 1 or 2, wherein the filtering material is a two-layer composition containing about 99 to about 85% by volume of a granular non-sorptive material with a specific weight of no less than aobut 1.5 g/cm³ and about 1 to about 15% by volume of an ion-exchange resin; wherein the purification process is carried out in dynamic conditions with cyclically alternation the purification with regeneration of working elements, the liquid flow being directed from the bottom upwards; and at the end of each regeneration cycle the mixture of materials is stratified by stopping the liquid flow for about 5.0 to about 2.0 min to stratify the materials.

4. The method of claims 3, wherein in purification of liquids containing hydrophobic components, filtering material is a hydrophobic synthetic polymer or a granular material with hydrophobic coating.

5. The method of claim 1, wherein prior purification process of hydrophobic liquids filtering material, hydrophilic or hydrophilized by passing a water volume there through is used.

6. The method of claim 5, wherein flows of the liquid being purified are directed alternatively along surfaced of cathodes and anodes, and flows slipping along electrically inactive walls of a working chamber are minimized.

7. The method of claims 6, wherein the combined regeneration of all working elements participating in the basic process is carried out by forming a flow of a regeneration liquid in the direction coinciding with a flow of gas bubbled released in electrolysis or supplied additionally.

8. The method of claim 7, wherein the regeneration process is carried out with additionally bubbling from the outside, gas bubbles of size of about 0.1 to about 10 mm with a relative intensity of about 0.01 to about 0.1 dm³/s per 1 dm³ of the filtering material.

9. An apparatus for purifying and neutralizing polluted liquids, comprising a housing encompassing electrodes connected to a polarization voltage source, a filtering material in the form of dispersed non-sorptive particles, the filtering material not completely filling the housing, and systems of pipelines with gates, and additional electrode cells mounted at inlet and outlet, wherein two pipelines with flow distributors are mounted in the housing above and under the electrodes and separated from the filtering material by a protective screen with openings smaller than about 0.1 mm; on the side opposite to the flow distributors the pipelines are provided with tees and gates adapted to switch the upper distributor and to supply the liquid being purified or discharged the regenerating liquid, and to switch the lower distributor to collect the purified liquid or supply the regenerating liquid; and a gas-separation valve mounted on an upper lid of the housing.

10. The apparatus of claim 9, wherein a pressing plate is mounted above the filtering material with the system of electrodes and provided with a mechanical or electromechanical actuator to lift the plate for releasing the filtering material, and a third pipeline with a flow distributor, a tee and gates at the end opposite to the distributor is provided in the apparatus housing under the pressing plate to discharge the purified and neutralized liquid or to drain the washing liquid after the regeneration.

11. The apparatus of claim 9 or 10, wherein a perforated plate with effective size of openings no more than about 25 mm is mounted, as a pressing plate, above the filtering material with the system of electrodes.

12. The apparatus of claim 11, wherein the additional electrode cells at inlet and/or outlet of the apparatus are connected to separate channels or power sully units, and have total areas of anodes and cathodes, differing in size by a factor of about 1.5 or more.

13. The apparatus of claim 11, wherein the additional electrode cells at inlet and/or outlet of the apparatus are provided with semi-permeable membranes dividing cell spaces into anode and cathode chambers, and throttles to provide different space velocities of partial flows passing along cathodes and anodes.

14. The apparatus of claim 9, wherein at least one of the additional electrode cells Has a symmetric electrode system and is filled with an ion-exchange resin balanced by ion content with the liquid passing therethrough.

15. The apparatus of claim 14, wherein a pressure or flow sensor electrically coupled to a voltage supply having a de-energizing device is mounted at inlet or outlet branches.

16. The apparatus of claim 15, wherein one or more pipelines connected to a compressor are provided in the lower part of the housing.

17. The apparatus of claim 16, wherein the gates are electromagnetically controlled and connected to a timer specify a time diagram of operations in purification and regeneration of working elements of the apparatus.

18. The apparatus of claim 17, wherein a monoblock distributor system with a timer is connected to the apparatus to carry out all operations of purification of liquid and regeneration of working elements of the apparatus in accordance with a predetermined routine.

19. The apparatus of claim 18, wherein the electrode systems in the housing of the apparatus are divided into two or more packs located in succession along the liquid flow and comprising parallel electrodes disposed perpendicularly or transversely to electrode surfaces in any of adjacent packs, and the inner surfaces of the housing are provided, up to the upper level of the electrode packs, with ribs or ridges perpendicular to the direction of the flow of liquid being purified.
